(19) United States
(12) Patent Application Publication
(10) Pub. No.: US 2010/0018550 A1
(43) Pub. Date: Jan. 28, 2010

(54) CLEANING COMPOSITIONS WITH VERY LOW DIELECTRIC ETCH RATES

(75) Inventors: George Schwartzkopf, Washington, NJ (US); Ewa Oldak, Fountain Hill, PA (US); Shahriar Naghshineh, Allentown, PA (US)

Correspondence Address: DESIGN IP, P.C., 5100 W. TILGHMAN STREET, SUITE 205, ALLENTOWN, PA, 18104, US

(73) Assignee: Surface Chemistry Discoveries, Inc., Bethlehem, PA (US)

(21) Appl. No.: 12/505,690

(22) Filed: Jul. 20, 2009

Related U.S. Application Data
(60) Provisional application No. 61/135,943, filed on Jul. 25, 2008.

(51) Int. Cl. C23G 1/00; C11D 3/60

(52) U.S. Cl. 134/2; 510/175

(57) ABSTRACT

Aqueous cleaning compositions comprising a tertiary organic amine, an organic acid, a non-metallic fluoride salt, a corrosion inhibitor, e.g., ascorbic acid or its derivatives alone or in combination, balance water, effective to remove plasma processing residues (sidewall polymer) which include metal-organic complexes and/or inorganic salts, oxides, hydroxides or complexes which form films or residues either alone or in combination with the organic polymer resins. These compositions clean effectively at low temperatures without etching metal or dielectric layers, including low-κ dielectric materials.

### CROSS REFERENCE TO RELATED APPLICATION(S)

This application claims priority from U.S. Patent Application No. 61/135,943 filed Jul. 25, 2008, which is incorporated by reference as if fully set forth.

### FIELD OF INVENTION

The present invention relates to improved cleaning compositions comprising tertiary organic amines, particularly, 2-dimethylaminoethanol, an organic acid, non-metallic fluoride containing salts, a corrosion inhibitor, particularly ascorbic acid, and water. These compositions may contain elevated concentrations of fluoride ion yet etch dielectric layers, including low-κ materials, very slowly.

### BACKGROUND OF THE INVENTION

The present invention relates to a cleaning composition for semiconductor substrate surfaces used in the Back End of The Line (BEOL) production steps during the manufacture of semiconductor devices, in particular those semiconductor devices where copper is used as the conductor and interconnects. During BEOL manufacturing steps used in the production of the newest semiconductors and semiconductor microcircuits, copper (Cu) is used to produce the latest high-density devices. Surface etching of the various substrates is one step utilized to build the circuits during manufacturing of a semiconductor device. Following these etching processes the remaining photoresist, comprising an organic coating deposited on the substrate to be etched, is removed by wet or dry stripping methods, generally called ashing. Subsequently it is necessary to remove any residual organic and inorganic contamination remaining, commonly referred to as sidewall polymer (SWP). This SWP typically consists of post etch and post ash residues such as polymers, salts, metallic contamination and particles. It is desirable to develop an improved cleaning composition to remove the SWP without corroding, dissolving or increasing the resistance of the metal circuitry or damaging dielectric materials that are present.

The most current BEOL technology utilizes dielectric materials with very low dielectric constants, termed “low-κ dielectrics.” Some of these materials are designed to actually be porous which leads to extreme chemical sensitivity, particularly to fluoride ion. However, fluoride ion is an effective cleaner component for removing SWP. It is therefore desirable to provide solutions containing the useful fluoride ion but formulated such that these compositions can be used to remove various types of residues from copper substrates and dielectrics without degrading or destroying the device.

U.S. Pat. No. 5,997,658 to Peters et al. discloses cleaning compositions comprising water, an alkanolamine and a corrosion inhibitor being one of, benzotriazole, gallic acid and gallic acid esters.

U.S. Pat. No. 5,597,420 to Ward discloses a cleaning composition free of hydroxylamine compounds that consists essentially of monoethanolamine and water together with a corrosion inhibitor. The preferred inhibitor includes gallic acid and its esters.

U.S. Pat. Nos. 6,326,130 and 6,749,998 to Schwartzkopf et al. disclose photoresist strippers containing reducing agents to reduce metal corrosion. This patent teaches the use of ascorbic acid, gallic acid, and pyrogallol among others for the control of metal corrosion in alkali containing components.

U.S. Pat. No. 5,143,648 to Satoh et al. discloses novel ascorbic acid derivatives as antioxidants.

U.S. Pat. No. 6,627,587 to Nagshineh et al. discloses cleaning compositions comprising monoethanolamine, a tetraalkylammonium hydroxide, fluoride ion, ascorbic acid, and water.

U.S. Published Pat. Application No. 2004/0266637 A1 to Rovito, et al. discloses aqueous etch residue removers and cleaners which contain fluoride and are buffered at pH 7.0 to 11.0.

Currently, available cleaning compositions have demonstrated excessive etch rates for copper and for low-κ dielectrics, particularly for those dielectrics that possess considerable porosity. Such etch rates may cause damage to the integrated circuit device under fabrication rendering it unusable.

### SUMMARY OF THE INVENTION

A suitable aqueous cleaning composition has been discovered that eliminates or substantially reduces the disadvantages or drawbacks of copper corrosion or dielectric attack.

Cleaning compositions according to the present invention consist of a tertiary organic amine, an organic acid, a fluoride containing salt, an effective amount of a corrosion inhibitor, balance water, the composition having a pH from 8 to 9.

Cleaning compositions according to the present invention have high water content (up to about 80 wt %) resulting in low cost cleaners that may be safely transported, safely dispensed and the safe disposal of which may be readily accomplished.

Compositions according to the present invention have the following advantages over compositions of the prior art, namely, they:
(a) can be used to clean a multiplicity of surfaces including metals and dielectrics, hydrophobic and hydrophilic surfaces;
(b) an easily rinsed off with water, normally without any intermediate rinsing with an organic solvent;
(c) do not contain hydroxylamine, a widely used but hazardous microelectronics cleaner component;
(d) are water-based and do not contain organic solvents;
(e) can be used at low operating temperatures, typically about 35° C.;
(f) are not subject to performance deviations caused by incidental water adsorbed from the atmosphere or otherwise present;
(g) are useful for removing remaining residues and particles from microelectronic substrates and nano-structures after etching and ashing;
(h) have low metal etch rates;
(i) are compatible with dielectrics including spin-on-glass and low-κ materials;
(j) can be prepared metal-ion free; and
(k) do not contain undesirable chlorinated or phenolic components such as gallic acid, pyrogallol, and catechol

Therefore in one aspect the present invention is a cleaning composition comprising from about 10 to 20% by weight 2-dimethylaminoethanol, from about 1 to 10% by weight acetic acid, from about 0.3 to 3.5% by weight fluoride ion, a corrosion inhibitor being an effective amount of ascorbic acid; balance deionized water.

In another aspect the present invention is a method of cleaning a semiconductor device with a surface film or an etch residue containing one of a metal organic polymer, inorganic salt, oxide, hydroxide, complexes thereof, or combinations thereof, comprising the steps of: contacting the semiconductor device with a cleaning composition containing from 10 to 20% by weight 2-dimethylaminoethanol, about 1 to 10% by weight acetic acid, about 0.3 to 3.5% by weight fluoride ion, an effective amount of ascorbic acid corrosion inhibitor, balance water at a temperature of between 20° C. and 50° C. for a period of time between 0.5 minute and 10 minutes, rinsing the semiconductor in deionized water and drying the semiconductor device.

### BRIEF DESCRIPTION OF THE DRAWING(S)

FIG. 1 is a scanning electron microscope (SEM) photomicrograph of a dielectric layer deposited using tetraethylorthosilicate which was imaged, pattern transferred, then subject to photoresist removal by ashing with oxygen plasma.

FIG. 2 is a SEM photomicrograph of the pattern of FIG. 1 after cleaning with a composition according to the present invention.

FIG. 3 is a SEM photomicrograph of an aluminum-copper layer which was imaged, pattern transferred, then subject to photoresist removal by ashing with oxygen plasma.

FIG. 4 is a SEM photomicrograph of the pattern of FIG. 3 after cleaning with a composition according to the present invention.

FIG. 5 is a SEM photomicrograph of a fluorosilicate (FSG) layer which has been patterned to give a multiplicity of 65 nm vias.

FIG. 6 is a SEM photomicrograph of the via pattern of FIG. 5 after cleaning with a composition according to the present invention.

### DETAILED DESCRIPTION OF THE INVENTION

According to the present invention a cleaning composition consisting of water, tertiary organic amines, acetic acid, and a fluoride containing salt of a nonmetallic nature, is significantly improved by mixing therewith an effective amount of corrosion inhibitor being one of ascorbic acid or its derivatives.

A preferred amount of inhibitor is about 0.5 to 5% by weight.

The preferred tertiary organic amines are alkanolamines, and most preferably is 2-dimethylaminoethanol (DMEA). The preferred amount of amine is from about 10 to 20% by weight.

The preferred organic acid is acetic acid. The preferred amount of organic acid is from about 1 to 10% by weight. The preferred ratio of acetic acid to DMEA is about one to three by weight.

The preferred fluoride containing salts are tetraalkylammonium fluorides, ammonium fluoride and ammonium bifluoride, most preferably ammonium fluoride. The preferred amount of fluoride concentration is 0.3 to 3.5% by weight as fluoride.

The balance of the composition is water, preferably deionized water. The preferred amount of water is from about 65 to 80% by weight.

The preferred pH of the formulation is from about pH 8 to about pH 9.

The novel cleaning compositions of the invention exhibit significantly enhanced corrosion inhibiting action, low dielectric etch rates, and cleaning capabilities at low temperatures, properties not possible from the use of the individual components or in combination with other cleaning components. Particularly useful is the combination of the tertiary amine, 2-dimethyl-aminoethanol with acetic acid and ascorbic acid to produce a very low copper etch rate.

Cleaning compositions of the invention provide an effective cleansing action as well as superior copper corrosion protection and little or no attack on a wide variety of dielectrics, e.g. TEOS (tetraethylorthosilicate), fluorosilicate glass (FSG), organosilicate glass (OSG), thermal (silicon) oxide, hafnium oxide, and lanthanum oxide.

Aqueous cleaning compositions of the invention consist of, by weight, about 10 to 20% 2-dimethylaminoethanol in combination with about 1 to 10% acetic acid, about 0.3 to 3.5% fluoride ion, about 0.5 to 10% corrosion inhibitor, preferably ascorbic acid, balance water. A preferred composition uses from 1 to 5% by weight ascorbic acid. Preferably, the pH of the solution is from about pH 8 to about pH 9.

The method of the invention is carried out by contacting a substrate containing an etch residue comprising a metal-organic polymer, inorganic salt, oxide, hydroxide or complex or combination thereof as a film or residue, (i.e. sidewall polymer (SWP)), with the described stripping composition followed by rinsing and drying the substrate. The actual conditions, i.e., temperature, time, etc. depend on the nature and thickness of the complex (photoresist residue and/or sidewall polymer) material to be removed, as well as other factors familiar to those skilled in the art. In general, for the removal of etch residue, the device is dipped into a vessel containing the cleaning composition, at a temperature between 20-50° C. typically for a period of about 0.5-10 minutes, then rinsed with water and then dried with an inert gas or “spin dried.”

Examples of plasma processing residues (sidewall polymer) include, among others, metal-organic complexes and/or inorganic salts, oxides, hydroxides or complexes which form films or residues either alone or in combination with the organic polymer resins of a photoresist. The etch residues and/or SWP can be removed from conventional substrates known to those skilled in the art, such as silicon, silicon dioxide, fluorosilicate glass (FSG), boron phosphorous silicon glass (BPSG), organosilicate glass (OSG), thermal (silicon) oxide, hafnium oxide, lanthanum oxide, copper, tungsten, tantalum, aluminium, silicon carbide, tantalum nitride, titanium nitride and the like.

Concentrates of compositions according to the present invention may be prepared by reducing the percentage of water noted in the composition described above. The resulting concentrates can later be diluted with an amount of water necessary to produce the desired cleaning compositions.

The following examples are illustrative of the invention described herein.

### EXAMPLE 1

Removal of Photoresist Ash Residue from Multiple Dielectric Layers

Preferred Composition A was prepared by mixing 75 g of water, 15 g of 2-dimethylaminoethanol, 5 g of glacial acetic acid, 5 g of ammonium fluoride, and 1 g of ascorbic acid.

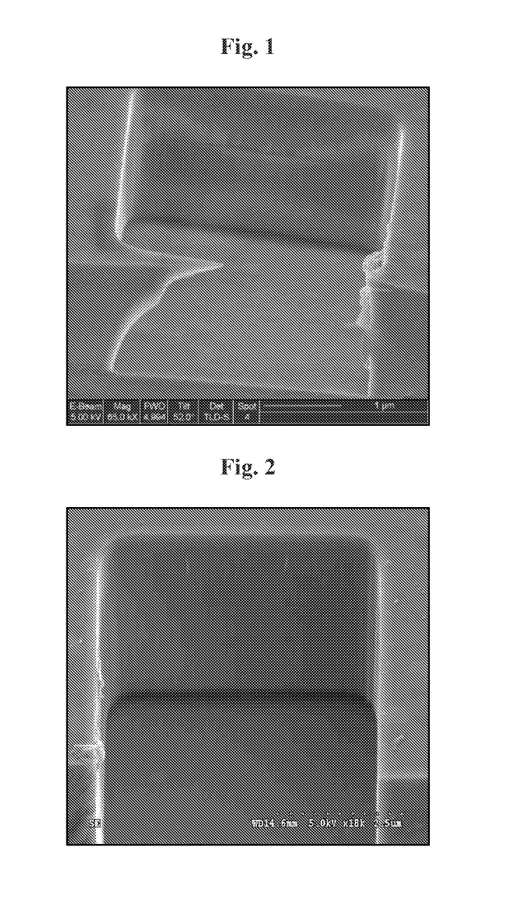

A 700 nm dielectric layer was deposited using tetraethylorthosilicate (TEOS), capped with 200 nm of silicon nitride, and followed by another 1,650 nm of dielectric (from TEOS). These layers were imaged with a pattern of 1-2 micron squares using a photoresist then pattern transfer by reactive ion etching (RIE). Most of the photoresist was then removed by ashing with an oxygen plasma. FIG. 1 is a Scanning Electron Microscope (SEM) photomicrograph of the resulting feature before cleaning. FIG. 2 is a SEM photomicrograph of this feature after cleaning with composition A at room temperature for 45 seconds. The photoresist residue on the back of the square has been completely removed without any damage to the dielectric.

### EXAMPLE 2

Removal of Photoresist Ash Residue from Aluminum Lines and Spaces

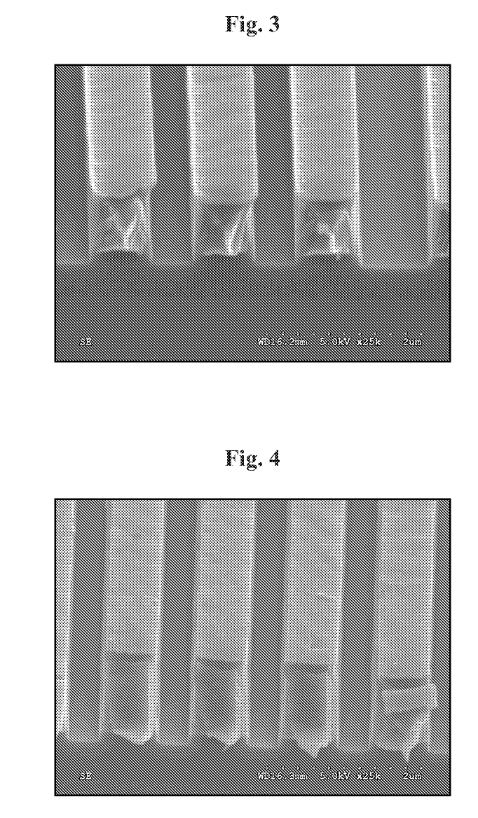

A 10 nm titanium silicon nitride layer was deposited and capped with 11 nm of titanium, and followed with 700 nm of aluminum-copper. The metal was imaged with a pattern of about 0.7 micron lines and spaces using a photoresist then pattern transfer by RIE. Most of the photoresist was then removed by ashing with an oxygen plasma. FIG. 3 is a SEM photomicrograph of a cross section of the resulting feature before cleaning. The appearance of bright upper edges on the metal lines indicates contamination of this surface with photoresist ash residue. FIG. 4 is a SEM photomicrograph (after cross-sectioning) of this feature after cleaning with composition A at room temperature for 90 seconds. The photoresist ash residue on the tops of the metal lines has been completely removed without any damage to the metal.

### EXAMPLE 3

Compatibility with High Aspect Ratio Vias in Fluorosilicate Glass

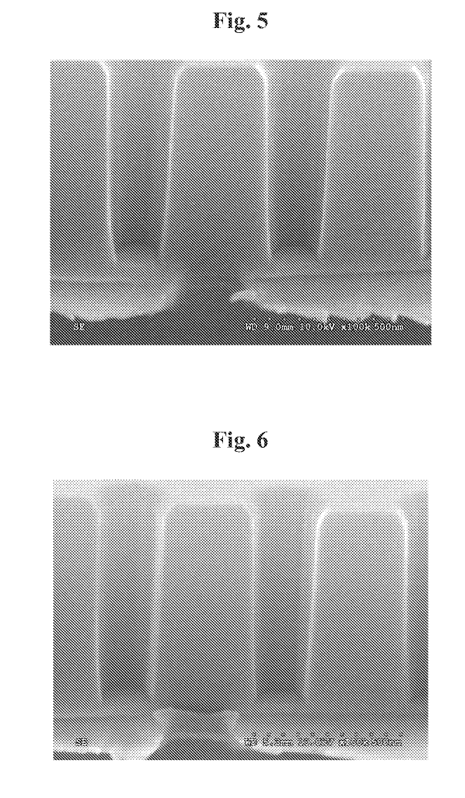

Wafers were coated with 0.65 microns of fluorosilicate glass (FSG) followed by imaging, pattern transfer, and resist removal to give a multiplicity of 65 nm vias. FIG. 5 is a SEM photomicrograph of a cross section of the resulting high aspect ratio vias. FIG. 6 is a SEM photomicrograph (after cross-sectioning) after treatment with composition A for 60 seconds at an elevated temperature of 40° C. The dimensions and appearance of these sensitive small features was completely unaffected by composition A indicative of high compatibility with the FSG dielectric. Similar results were obtained for 65 nm vias in an organosilicate glass (OSG), another sensitive dielectric.

### EXAMPLE 4

Compatibility with Dielectrics and Metals

Etch rates were determined for Composition A with various important microelectronic materials. These rates were consistently low, and exceptionally low for the dielectric materials. The results are listed in Table I.

TABLE I

| | Test Temperature | Etch Rate | Etch Rate |
|---|---|---|---|
| Material | (° C.) | (Å/min) | Determination Method |
| copper | 35-45 | <0.5 | gravimetric using pure |
| | | | metal foil |
| tantalum | 35-45 | <0.2 | gravimetric using pure |
| | | | metal foil |
| aluminum | 35-45 | 3 | gravimetric using pure |
| | | | metal foil |
| silicon carbide | 40-45 | 0 | ellipsometric |
| titanium nitride | 45 | 0 | ellipsometric |
| tantalum nitride | 45 | 0 | ellipsometric |
| thermal (silicon) | 45 | 0.3 | ellipsometric |
| oxide | | | |
| TEOS derived | 30 | 0 | ellipsometric |
| dielectric | | | |
| hafnium oxide | 45 | 0 | ellipsometric |
| lanthanum oxide | 45 | 0.3 | ellipsometric |

Various changes and/or modifications to the invention described herein can be made without departing from the spirit and scope of the invention as defined in the claims set forth below.

Having thus described our invention what is desired to be secured by Letters Patent of the United States is set forth in the appended claims.

What is claimed is:

1. A cleaning composition comprising a tertiary organic amine, an organic acid, a fluoride containing salt, an effective amount of a corrosion inhibitor, balance water wherein the pH of the composition is from about pH 8 to pH 9.

2. A cleaning composition according to claim 1, wherein the corrosion inhibitor is ascorbic acid present in an amount of about 0.5 to 5% by weight.

3. A cleaning composition according to claim 1, wherein the tertiary organic amine is 2-dimethylaminoethanol and is present in an amount of about 10 to 20% by weight.

4. A cleaning composition according to claim 1, wherein the organic acid is acetic acid present in an amount of about 1 to 10% by weight.

5. A cleaning composition according to claim 1, wherein the fluoride containing salt is ammonium fluoride wherein the composition contains 0.3 to 3.5% by weight as fluoride ion.

6. A cleaning composition according to claim 2, consisting essentially from about 10 to 20% by weight 2-dimethylaminethanol, from about 1 to 10% by weight acetic acid, from about 0.3 to 3.5% by weight fluoride ion, from about 0.5 to 5% by weight ascorbic acid; balance deionized water.

7. A cleaning composition according to claim 6, consisting essentially of from about 15% by weight 2-dimethylaminethanol, about 5% by weight acetic acid, about 5% by weight ammonium fluoride, about 1% by weight ascorbic acid; balance deionized water.

8. A method of cleaning a semiconductor device having a metal organic polymer, inorganic salt, oxide, hydroxide, and/or complexes or combinations thereof as a film or residue comprising the steps of:
preparing a cleaning composition having a pH between 8 and 9 containing a tertiary organic amino, an organic acid, a fluoride containing salt, an effective amount of a corrosion inhibitor, balance water;
contacting said semiconductor device with said cleaning composition at a temperature of between 20° C. and 50° C. for a period of time between 0.5 minute and 60 minutes;
rinsing said semiconductor device in deionized water; and
drying said semiconductor device.

9. A method according to claim 8 comprising the steps of preparing the composition with from 0.5 to 5% by weight acetic acid.

10. A method of cleaning a semiconductor device having a metal organic polymer, inorganic salt, oxide, hydroxide, and/or complexes or combinations thereof as a film or residue comprising the steps of:
Preparing a cleaning composition having a pH between 8 and 9 containing 10 to 20% by weight tertiary organic amine, 1 to 10% by weight acetic acid, 0.3 to 3.5% by weight fluoride, from 0.5 to 5% by weight ascorbic acid, balance water;
contacting said semiconductor device with said cleaning composition at a temperature of between 20° C. and 50° C.;
rinsing said semiconductor device in deionized water; and
drying said semiconductor device.
